(19) United States
(12) Patent Application Publication
(10) Pub. No.: US 2006/0200383 A1
(43) Pub. Date: Sep. 7, 2006

(54) Enhanced maps, such as for lead generation

(76) Inventors: Ethan B. Arutunian, Seattle, WA (US); Gregg Eskenazi, Mercer Island, WA (US); Ian Morris, Kirkland, WA (US); David E. Huey, Bellevue, WA (US)

Correspondence Address: PERKINS COIE LLP;PATENT-SEA, P.O. BOX 1247, SEATTLE, WA, 98111-1247, US

(21) Appl. No.: 11/207,600

(22) Filed: Aug. 19, 2005

Related U.S. Application Data
(60) Provisional application No. 60/667,370, filed on Mar. 31, 2005.
(60) Provisional application No. 60/658,858, filed on Mar. 3, 2005.

(51) Int. Cl. G07G 1/14

(52) U.S. Cl. 705/14

(57) ABSTRACT

Providing access to a map via a communication network may include providing multiple map images. The images may be configured (e.g., using map tiles and mathematical projections) to allow the user to zoom in from a large geographical area on the map to a smaller geographical area on the map. At least one data overlay showing information about points of interest may be displayable on the map. Information relating to use of the provided maps may be collected, such as contact information for at least one user of the map and information associated with at least one item or area from the map that is of interest to the user. Based on the collected information, a lead or set of leads may be established for use by at least one provider of products or services.

### CROSS-REFERENCE TO RELATED APPLICATION(S)

This application claims the benefit of U.S. Provisional Application No. 60/667,370 entitled “System and Method Utilizing Enhanced Aerial Imagery, Such As For Providing Information Associated With Locations of Interest Including Real Estate,” filed Mar. 31, 2005, and U.S. Provisional Application No. 60/658,858 entitled “Method and System for Commercial Use of Aerial Images,” filed Mar. 3, 2005, which are both incorporated by reference.

### BACKGROUND

The Internet is increasingly being used to conduct “electronic commerce,” in part, because it facilitates electronic communications between vendors and purchasers. For example, the Internet may be used to unite sellers of goods or services, such as with purchasers wishing to buy such goods or services. For example, some web sites allow users to enter specific data with respect to items they wish to purchase or sell. After uniting a buyer with one or more merchants, the parties may then complete a business transaction. Often, these web sites, acting as intermediaries or “infomediaries,” facilitate commercial transactions more automatically and in a more targeted fashion than prior systems such as advertising, cold-calling, etc.

There are many existing web sites that act as intermediaries between buyers and sellers (e.g., sites related to buying and selling automobiles, real estate, electronics, pets, etc.). Thus, finding ways to attract users to a particular site is often an important consideration. In addition, once users are convinced to use a particular site, providing useful information, especially with respect to the products or services being promoted on the site, may be helpful in retaining users and encouraging commerce.

### BRIEF DESCRIPTION OF THE DRAWINGS

FIG. 1 is a block diagram illustrating components of a real estate lead generation system using enhanced aerial imaging under one embodiment of the invention.

FIG. 2 is a block diagram showing an example of a database scheme that may be used for providing enhanced aerial imaging in the embodiment of FIG. 1.

FIG. 3 is a block diagram showing an example of a database scheme that may be used for providing lead generation in association with enhanced aerial imaging in the embodiment of FIG. 1.

FIGS. 4A-4G are display diagrams showing examples of screenshots at various stages of interaction between a user and an enhanced aerial mapping facility in an embodiment.

FIGS. 5A-5C are display diagrams showing examples of screenshots showing various data overlays as applied to an enhanced aerial mapping facility in an embodiment.

FIG. 6 is a display diagram showing an example of a screen where a user can access various overlays and associated features through the use of a tab on a user interface in an embodiment.

FIG. 7 is a display diagram showing an example of a screen where a user can access detailed information about selected properties through the use of a tab on the user interface in the embodiment of FIG. 6.

FIG. 8 is a display diagram showing an example of a screen where a user can access detailed history/tax information about a selected property through the use of a tab on the user interface in the embodiment of FIG. 6.

FIGS. 9A-9E are display diagrams showing examples of data charts/reports used in conjunction with the enhanced aerial maps in an embodiment.

FIG. 10 is a flow diagram of a representative implementation of a lead generation routine performed by the lead generation server of FIG. 1 in an embodiment.

FIG. 11 illustrates a display for requesting data from a homeowner.

FIG. 12 illustrates a comparable market analysis form completed by the real estate professional based on the representative data.

FIG. 13 illustrates a home evaluation web page for display to the homeowner based on the comparable market analysis form.

FIG. 14A illustrates a real estate professional's contact management web page that permits a real estate professional to manage homeowner leads.

FIG. 14B illustrates a real estate professional's homeowner prospect profile web page that permits a real estate professional to view and update homeowner leads.

### DETAILED DESCRIPTION

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

It is intended that the terminology used in the description presented be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

I. Overview

A computerized aerial mapping system or facility with possible enhancements provides various map-based features using aerial map information along with other information. In some embodiments, the aerial mapping facility presents a nationwide aerial map to a user using, for example, aerial photographs or satellite imagery and allows a user to “zoom in” on an area or even on a specific property of interest (e.g., a house on Seattle's Lake Washington).

The aerial mapping facility may incorporate an overlay of multiple listing service (MLS) data that allows the aerial mapping facility to provide special indications of houses and/or properties that are for sale (e.g., properties for sale may be highlighted on the map using a colored outline around the property). In addition to MLS data overlays, many different types of data overlays may be applied to the aerial map information and this data may be obtained from a variety of data sources. Examples of such information may include county tax parcel location data, tax assessor data, data regarding points of interest, local weather data, average house price, cost-of-living estimates, yellow pages data, etc. In general, the overlay information may include any type of location-based data. The aerial mapping facility may also integrate various type of geographic vector and point data (e.g., shown as drawn-in information in the aerial map) so that streets, boundaries, and other information that are not evident from the aerial picture alone may be identified.

In some embodiments, users may access the aerial mapping facility from a web site. The web site server may employ a viewer that allows a user to zoom in on a map via a web browser without needing to download a specific client application. Any range of zooming may be implemented. For example, at the highest level, the map may cover an entire country or continent, or even the whole world. It may also be possible to include maps from the aerial mapping facility in emails or other types of user notifications. For example, a user may sign up for a “Just Listed” service that enables him or her to receive emails (containing aerial map features, photos, etc.) each time a home or property goes up for sale in an area of interest that the user has identified. In some cases, the user may be able to set filters to include/exclude certain new listings (e.g., listings outside of the user's price range and/or size requirements). In a similar example, an email update may be sent to a user that includes recent home sales within the user's area, and may include a picture or map. Information regarding open houses in the area may also be provided in this way (with or without a map). In some cases, it may be possible for a user to designate an area of interest by “lassoing” an irregularly shaped area using a graphical interface tool provided by the aerial mapping facility.

A provider of the aerial mapping facility may generate revenue in multiple ways. In some embodiments, it may be possible to license to various real estate professionals access to aspects of the aerial mapping facility. For example, by performing certain actions from a primary web site provided by the aerial mapping facility, the facility may take the user to a real estate professional's personal home page. In addition, this real estate professional may have registered and paid a fee to receive bundles of leads generated by users zooming in within a designated geographical area. In this way, the aerial mapping facility may be used to collect information from consumers (e.g., home buyers and home sellers) in order to generate leads (e.g., bundles of leads) for real estate professionals or, more generally, providers of goods or services. To enable the collection of leads, users may be taken to a registration page after zooming in on certain features of the map.

A provider of the aerial mapping facility may also generate revenue by allowing click-through access to an advertiser's own web page via the maps. For example, a user that clicks on a home identified as being for sale on the map may be taken to the selling agent's home page. Likewise, clicking on an indication of a restaurant on the map may take the user directly to the web page for the restaurant. In a similar example, an advertiser may pay a fee for each time its icon is displayed on the map as a point of interest (e.g., advertiser pays two cents each time its fast food icon is displayed on a map as a point of interest).

In yet another example, revenue may be generated by having real estate professionals license the mapping technology so that they can provide it from their own personal web pages (independent of whether the real estate professional has registered to receive leads generated using the primary mapping web site). For example, in such cases, the provider of the aerial mapping facility may host the real estate professional's web site and thereby provide the mapping technology.

In some embodiments, the user may be introduced to the aerial mapping facility via a video demo that starts automatically when the user first arrives at a home page associated with the aerial mapping facility. Some of the options provided to users from the home page may include viewing an aerial image of the user's own home (e.g., by entering address information into text fields), searching homes for sale (e.g., by zooming in on desired areas using the interactive map), seeing the prices of recently sold homes, etc. Registration opportunities may exist at various times during a user's interactive session. For example, if the user selects to search for homes for sale, a screen asking the user if he or she wants to register may first pop up.

In some embodiments, the aerial maps provided by the aerial mapping facility may include color-coded aspects. For example, an age map may show the age of homes using yellow (for newly built homes) fading to red (for older homes), thus using color to show a concentration of new versus older homes in a selected area. In addition to color, other indicators may be used to identify items of interest (e.g., special icons, flashing identifiers, audio identifiers, etc.) For example, flashing may be used to indicate items of interest, such as an open house.

The mapping technology may be available from a user's personal computer, as well as from other user devices including portable devices (e.g., mobile phones and computers in automobiles).

II. Representative Environment and Sample Data Scheme

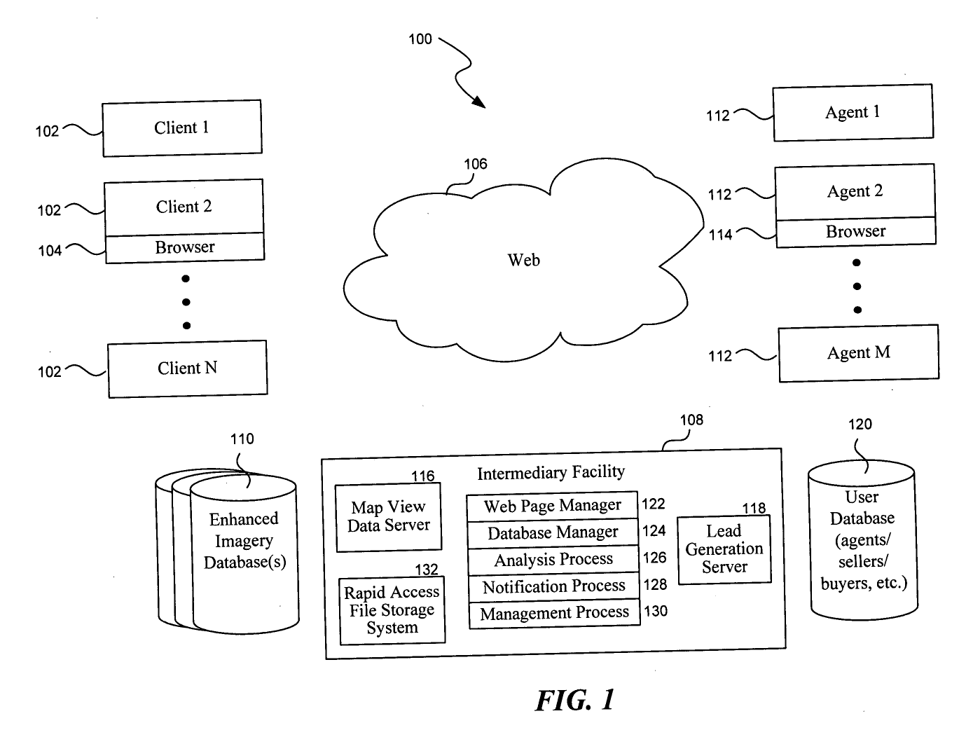

FIG. 1 and the following discussion provide a brief, general description of a suitable computing environment in which the invention can be implemented. Although not required, embodiments of the invention will be described in the general context of computer-executable instructions, such as routines executed by a general-purpose computer, such as a personal computer. Those skilled in the relevant art will appreciate that the invention can be practiced with other computer system configurations, including Internet appliances, hand-held devices, multiprocessor systems, microprocessor-based or programmable consumer electronics, network PCs, mini computers, mainframe computers, and the like. The invention can be embodied in a special purpose computer or data processor that is specifically programmed, configured, or constructed to perform one or more of the computer-executable instructions explained in detail below. The invention can also be practiced in distributed computing environments where tasks or modules are performed by remote processing devices, which are linked through a communication network. In a distributed computing environment, program modules or sub-routines may be located in both local and remote memory storage devices.

Unless described otherwise, the construction and operation of the various blocks shown in FIG. 1 are of conventional design. As a result, such blocks need not be described in further detail herein, as they will be readily understood by those skilled in the relevant art.

Referring to FIG. 1, an enhanced aerial imagery system 100 may include one or more client computers 102, each of which includes a browser program module 104 that permits the client computer 102 to access and exchange data with the Internet, including web sites within the World Wide Web portion 106 of the Internet (or via another network such as a WAN or LAN, cellular phone network, etc.). The client computers 102 may include one or more central processing units or other logic processing circuitry, memory, input devices (e.g., keyboards and pointing devices), output devices (e.g., display devices and printers), and storage devices (e.g., fixed, floppy, and optical disk drives), all well known but not shown in FIG. 1. The client computers 102 may also include other program modules, such as an operating system, one or more application programs (e.g., word processing or spreadsheet applications), and the like.

An intermediary system or facility 108, coupled to the World Wide Web, or “Web” 106, performs much or all of the aerial mapping and lead generation processes. At least one enhanced imagery database 110, coupled to the intermediary facility 108, stores data exchanged between the client computers 102 and one or more agent computers 112 under the enhanced aerial imagery system 100, as described below. Other sources for data used by the enhanced aerial imagery system 110 may also exist, including third-party sources. Each agent computer 112 is similar to the client computers 102, and includes a browser 114 to permit the agent computer 112 to access and exchange information with the Web 106.

In some embodiments, the intermediary facility 108 may include a map view data server 116 for handling the serving of enhanced aerial images and/or a lead generation server 118 for handling lead generation for real estate professionals or other providers of goods or services. In some embodiments, the map view data server 116 handles various functionality, including allowing a user to zoom in and out on an enhanced aerial map without needing to download a specific client. The scope of the high level maps may range from a single property to the whole world. The map view data server may also provide miscellaneous tools, such as a graphical tool that allows a user to select an area of interest by drawing an irregularly shaped area on the map. A rapid access file storage system 132 may function to store image data and associated data when in use by the map view data server 116.

The lead generation server 118 may implement its own functionality related to lead generation (e.g., for real estate professionals). For example, the lead generation server 118 may employ an exclusive marker area (EMA) scheme where real estate professionals are exclusively (or semi-exclusively) assigned to areas (e.g., based on zip codes, census block data, or other factors), and then notified of users showing interest in homes in such areas. Information used by the lead generation server 118 may be stored in the user database 120. In a second example, the lead generation server 118 may access an external multiple listing service (MLS) to generate leads based on user requests that have been obtained through the MLS. These leads may then be bundled and sold in packages to subscribing parties. A combination of the two approaches described above may also be employed, where the lead generation server 118 generates leads through an EMA or similar scheme that are distributed and sold as bundles.

The intermediary facility 108 may also include a web page manager component 122, a database manager component 124, an analysis process component 126, a notification process component 128, and a management process component 130, as well as other components not shown in FIG. 1. As described more fully below, the notification process component 128 may facilitate electronic messaging, such as via email, among the client computers 102, intermediary facility 108, and agent computers 112. Alternatively, or additionally, the notification process 128 may provide notification to agents or clients (e.g., real estate professionals and homeowners, respectively) via telecommunications devices. In this way, the notification process may provide updates or other information to users, particularly potential buyers. For example, an email update could include recent sales information for an area, data regarding open houses in the area (with or without a map), open house data, etc. The intermediary system may allow users to specify areas for which they wish to receive such updates.

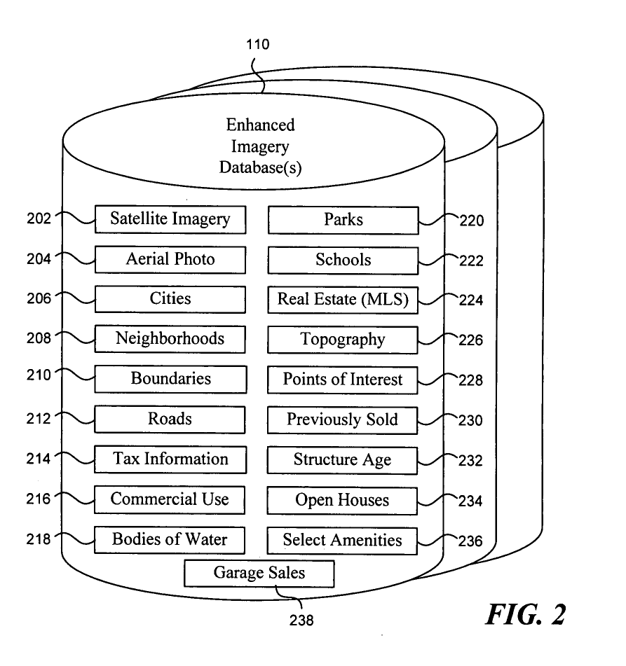

Referring to FIG. 2, the at least one enhanced imagery database 110 of FIG. 1 is shown in more detail. In some embodiments, the map view data server 116 may handle many different data sources, although in its simplest form, it may handle only an underlying map layer made up of satellite imagery 202, aerial photo imagery 204, and/or the like. These imagery data sources may sometimes be referred to as “Digital Orthorectified Quadrangles” (DOQs). Digital orthography is the process by which images are adjusted to account for elevation changes so that aspects of the image can line up appropriately. For example, the United States Geological Survey (USGS) has been making high-resolution imagery of this type available on a city-by-city basis. Likewise, many private companies provide such imagery.

In some embodiments, aerial imagery (202 and 204) is imported into the intermediary system 108 using one or more tools. For example, one or more tools may break down large image files into many smaller files (e.g., “map tiles”) and generate an index file to help locate the many smaller map tiles. The map tiles may go through some additional post-processing prior to use, such as coloring the water or re-coloring the map, or adding additional layers to the tiles. In some embodiments, map tiles need to be image files. Rather they can be any information/data that facilitates the electronic display of one or more maps. A single map displayed on a screen may be comprised of one or many map tiles.

In some embodiments, map tiles are flattened, two-dimensional images of a round (i.e. three-dimensional) Earth. The mathematical function for transforming a 3-D surface to a 2-D one is sometimes called a “projection”. Aerial images are stored in projections that cover relatively small areas localized to a given city, region, or state. This allows the flattened map tiles to represent the 3-D earth as accurately as possible. Additional point and vector layers (e.g. data overlays) may be added to the map. These layers can be stored in the same mathematical projection as the map itself, but more likely will be stored in either the original 3-D coordinate system (latitude/longitude) or a completely different mathematical projection entirely. In order to accurately overlay these points and vectors on the aerial images, all points are transformed in real-time from their original coordinate space to the map tile projection coordinate space.

In some embodiments, the one or more tools may generate such map tiles at many resolutions to enable effective zooming in/out. For example, each time a user zooms in on a map, a new set of map tiles (e.g., a three-by-three square of nine map tiles configured at a higher resolution and covering less geography) may replace an earlier set of map tiles (e.g., a three-by-three square of nine map tiles configured at a lower resolution and covering a greater geographical area). To enable quick exchange of map tiles, the one or more tools may request Information about relevant map tiles and the cache such information for later use. For example, while displaying information at one resolution, the one or more tools may anticipate that the user is going to want to zoom in and accordingly, request and cache a next higher resolution of map tiles. Likewise, the one or more tools may request adjacent map tiles and store and cache them in anticipation of a user performing “panning” on a currently displayed map. In this way, the user can experience near seamless panning, zooming, etc., despite the fact that images may themselves comprise large amounts of data.

Any number of overlays may be added on top of the map layer, with each overlay including additional data of interest. Sometimes, such overlays are purchased from vendors while others are downloaded free from government agencies. In some embodiments, the overlays may comprise information based on vectors, points, or both vectors and points. For example, U.S. city names information 206 may aggregated into a overlay that defines cities using points, which are then drawn as groups of pixels (or icons) on top of the aerial imagery to identify cities and associated information (e.g., state capitals, etc.). In another example, points of interest information 228 or select amenities information 236 may provide similar overlays using points (e.g., identifying restaurants, airports, libraries, museums, amusement parks, shopping centers, grocery stores, etc.). In some cases, the user using filters or searching techniques may access these points of interest.

Likewise, some overlays may be based on vector information and may provide displays of lines (as in the case of roads) and polygons (parcel outlines, park boundaries, state boundaries, etc.) on top of a map layer. For example, neighborhoods information 208, boundaries information 210, roads information 212, tax information 214, commercial use information 216, bodies of water information 218, parks information 220, schools information 222, etc., may all be defined and illustrated using vectors. Additional vector layers may be added when available. For example, a county parcel map (also called a “Base Map”) may be distributed by some county agencies and, when accurate, may be an appropriate overlay on aerial imagery. Like the points described above, these vector-based overlays may also be accessed by searching techniques (e.g., using keywords) or by filtering techniques, etc.

While specific types of layering/overlay schemes based on specific types of information are described above, almost any type of data that has any geographic relevance can also be tied to the maps of the aerial mapping facility. Such data may include county tax assessor records 214, real estate information related to current listings 224, topography information 226, real estate information related to past listings (previously sold) 230, information related to the age of various buildings or structures 232, real estate information related to open houses 234, information related to garage sales 238, census bureau and state traffic analysis (not shown), neighborhood and community statistics (not shown), geologic data, zoning data, construction or other permit data, etc. In some embodiments, the information used for overlays may be associated with more detailed information that may be presented when a user clicks on an object identified on a map. Likewise, it may be possible for the user to click to add or remove different layers of data. Each layer may be represented by a different color or other attribute (vector characteristic, etc.).

With respect to implementation of such overlays, in some embodiments, point and vector overlays can be delivered as database tables or flat files (e.g., ESRI shapefiles). Shapefile is the most common flat file format supported by nearly all Geographic Information System (GIS) data suppliers. In some embodiments, shapefiles are run through a tool associated with the intermediary facility 108 and imported into the database to allow faster lookup of the data when performing rendering. To help with the matching up of map images to overlay information, the overlay information, which may be implemented using points and/or vectors, may be structured using a geographical coordinate system similar to the geographical coordinate system used in GIS maps. In this way, mathematical projections can be used to match overlays with maps, so that the overlay information lines up with the map information as accurately as possible. For example, in some embodiments, point coordinates may be stored in a particular mathematical projection inside a file containing map or overlay information. Various aerial imagery coordinates may also be stored using mathematical projections, but such projections may not be the same as the projection for each point/vector layer. Because each point/vector layer consists of individual points and or vectors, those points/vectors can be “re-projected” to line up on the aerial imagery.

Alternatively, in addition to the data scheme described above, the aerial image maps can be integrated with data from other data sources, such as third party data sources. Accordingly, there are few limits on what types of information can be shown on such maps. Some examples include source specific information about points of interest, weather information, sports information, news information, current cost of living information, store hours information, and so forth.

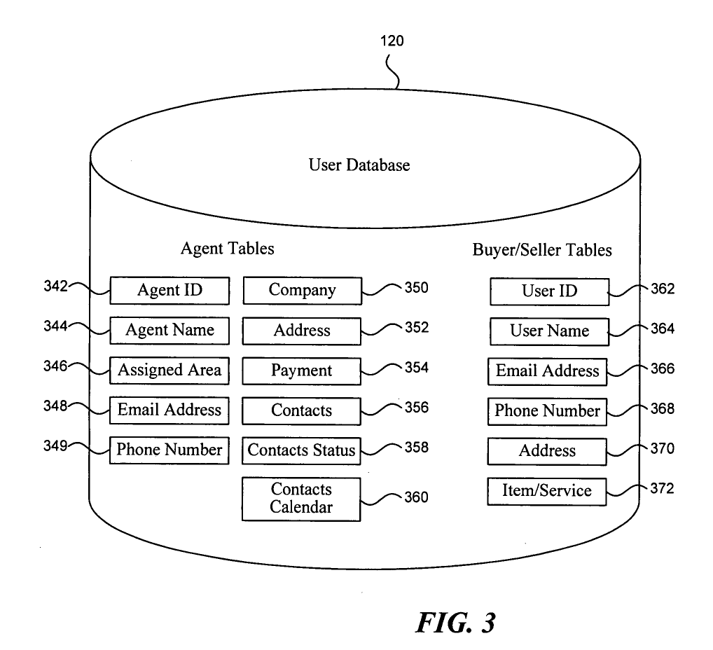

Referring to FIG. 3, the various users of the system may be assigned records in a user database 120 to facilitate lead generation or similar functionality. For example, each real estate professional (or other seller or provider of goods or services) may be assigned a user database record 340. Each record may include an agent ID field 342, an agent name field 344, an assigned zip code(s) field 346, an email address field 348, a phone number field 349, a company or employer field 350, an address field 352, a payment field 354, a contacts field 356, a contacts status field 358, and a contacts calendar field 360. Of course, each record can include some or all of these fields, or additional fields not shown in FIG. 3. In one embodiment, only one real estate professional is assigned to each zip code, although in alternative embodiments, more than one agent can be assigned to a single zip code.

In addition to records for agents/professionals, the user database may also include records for future purchasers of goods or consumers of a service (e.g., home buyers or sellers). For example, each record may include a user ID field 362, a user name field 364, an email address field 366, a phone number field 368, an address field 370, and one or more fields providing information on an item or service associated with the user 372 (e.g., identifying information about a home the user wishes to purchase or sell).

III. Sample User Interfaces

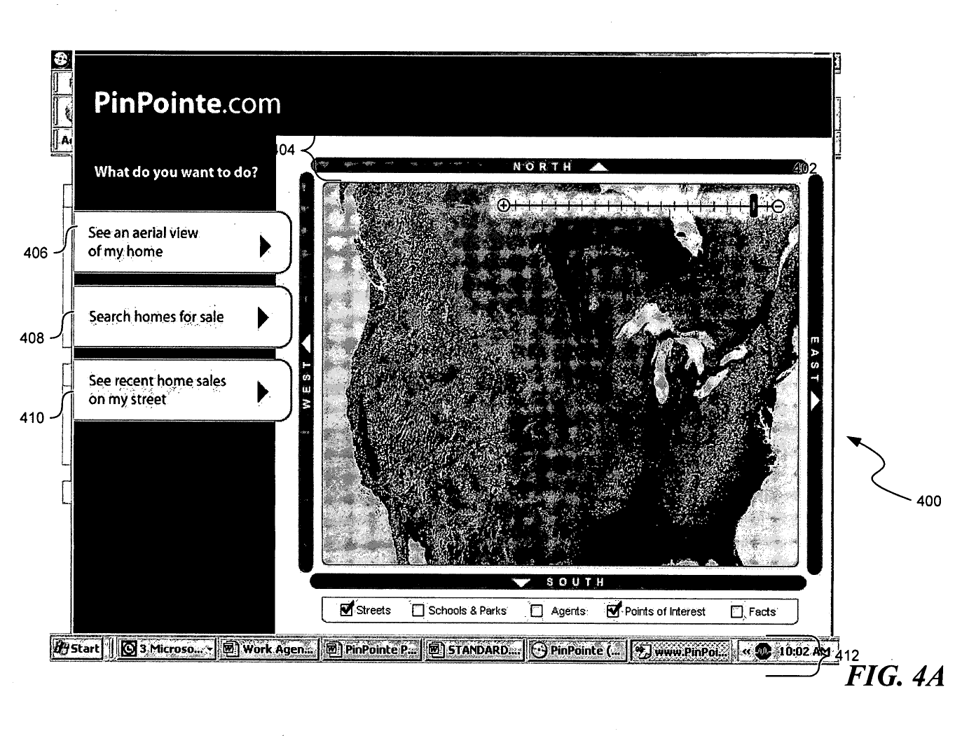

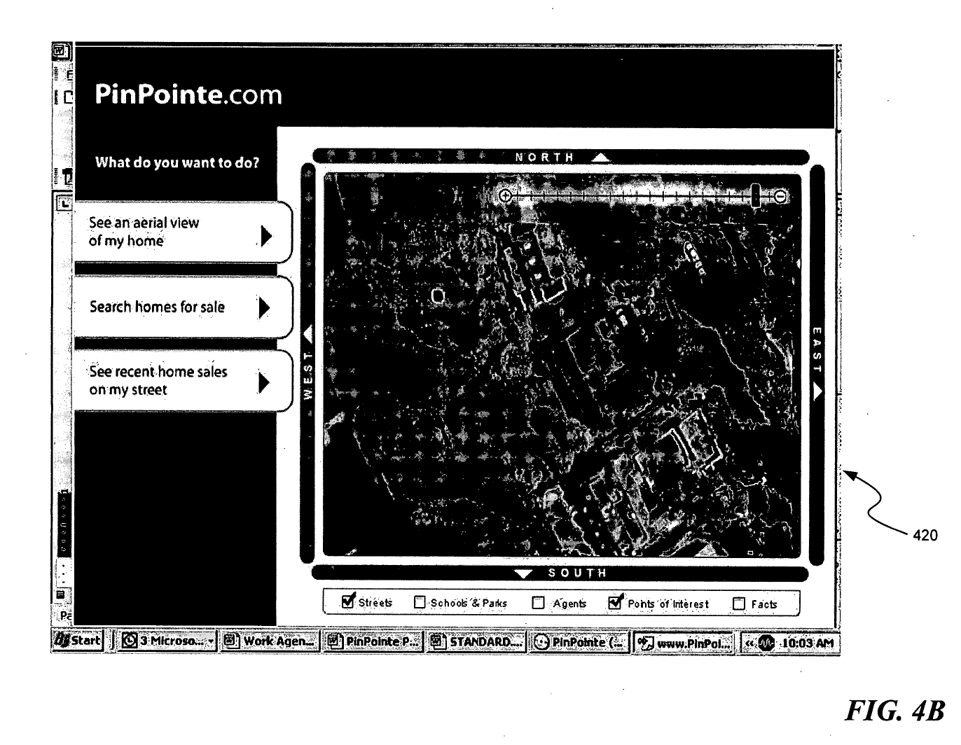

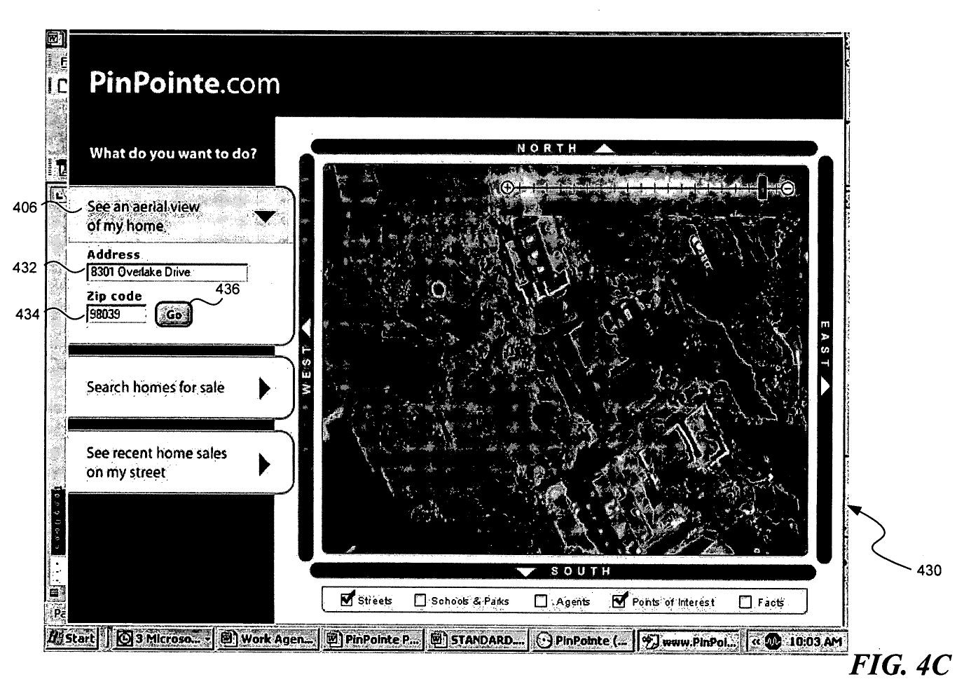

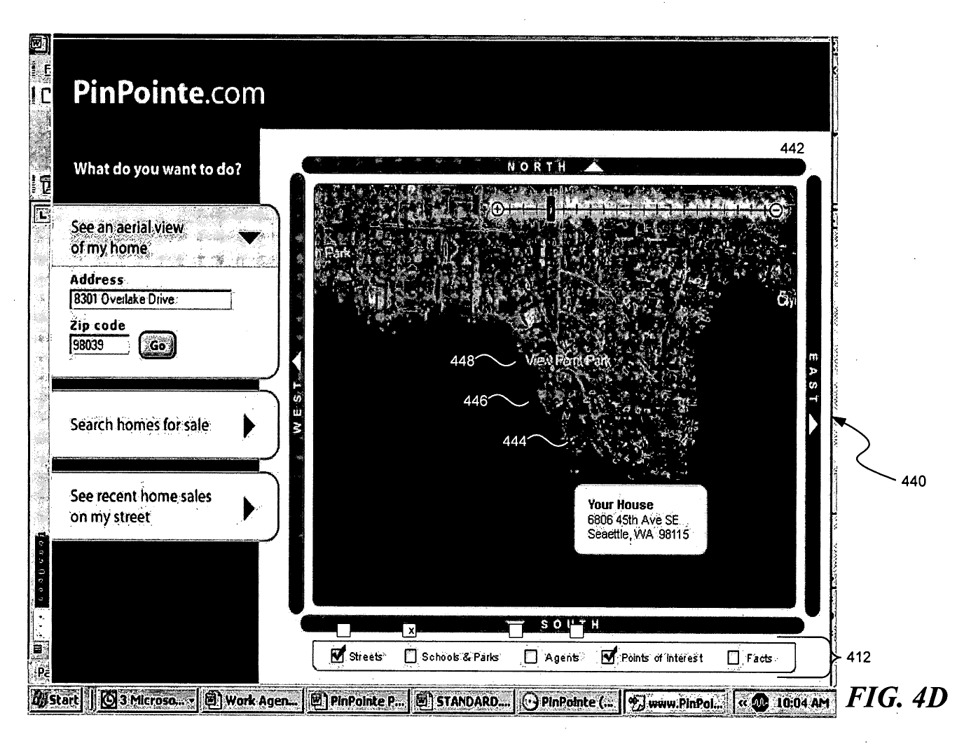

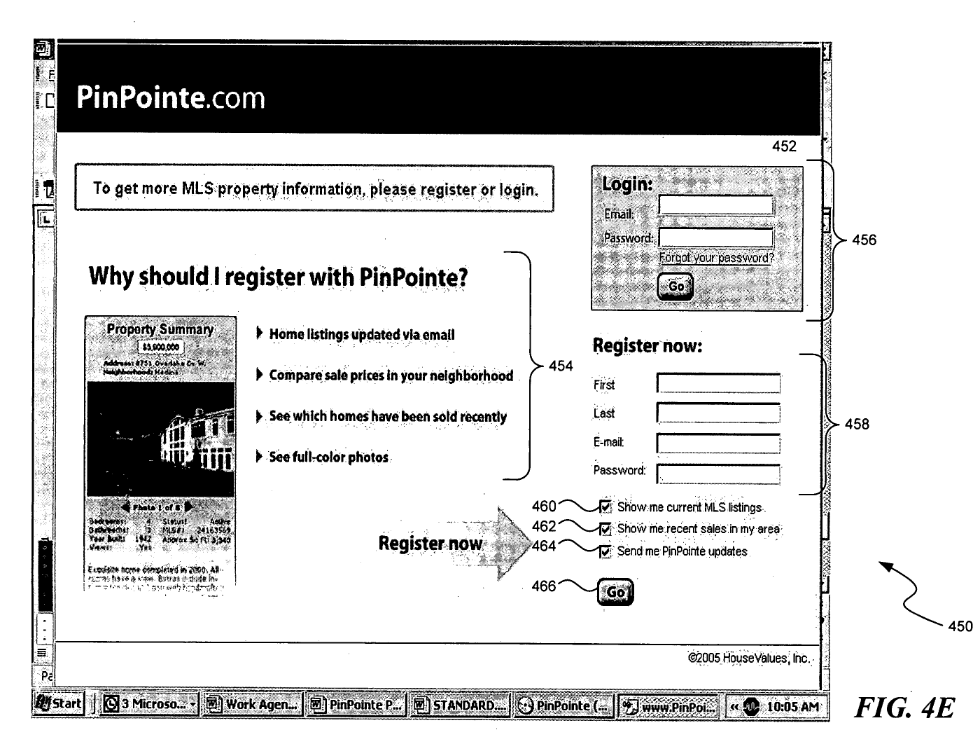

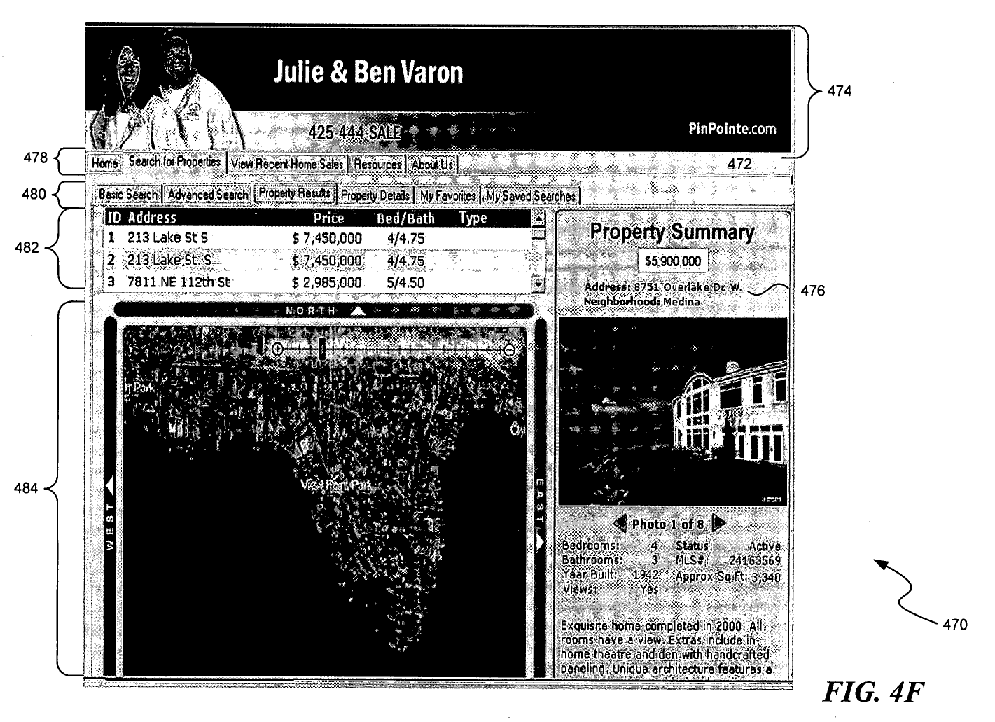

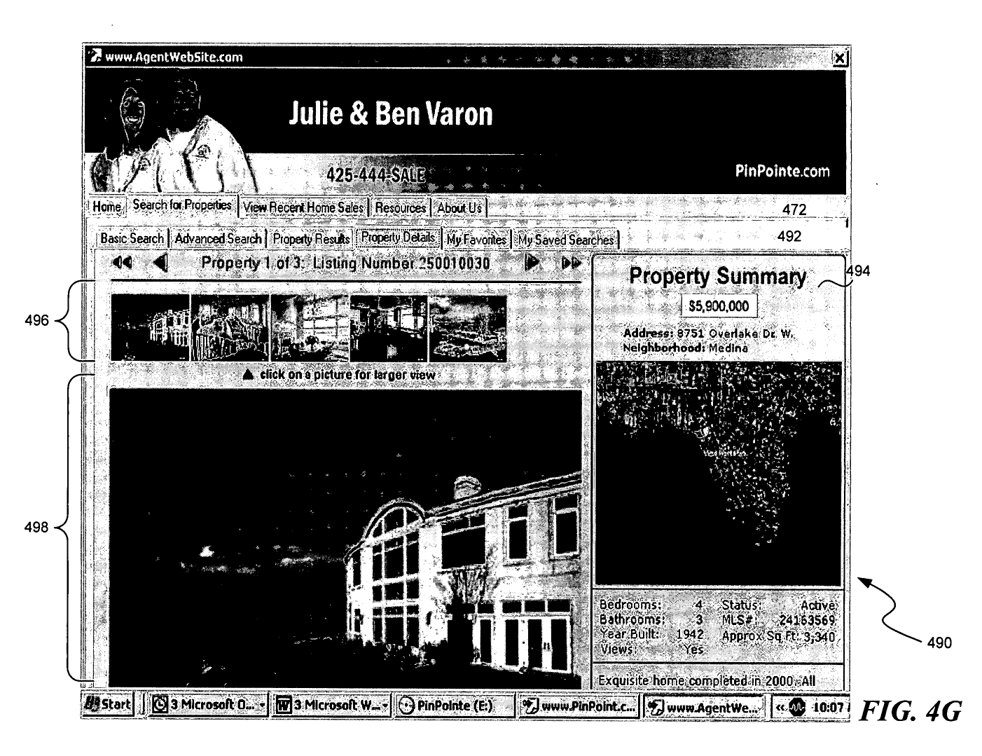

FIGS. 4A-4G, 5A-5C, 6-7, 8, and 9A-9E are display diagrams showing examples of various user interface features, screens, and/or web pages associated with embodiments of the aerial mapping facility. The screens or web pages of the Figures may be implemented in C++, Java, or JavaScript, or as web pages under XML (Extensible Markup Language), HTML (Hypertext Markup Language), Flash! ASP.net, or any other scripts or methods of creating displayable data, such as the Wireless Access Protocol (“WAP”). The screens or web pages provide facilities to receive input data, such as a form with fields to be filled in, pull-down menus or entries allowing one or more of several options to be selected, buttons, sliders, hypertext links or other known user interface tools for receiving user input. While certain ways of displaying information to users is shown and described with respect to certain Figures, those skilled in the relevant art will recognize that various other alternatives may be employed. The terms “screen,” “web page” and “page” are generally used interchangeably herein.

When implemented as web pages, the screens are stored as display descriptions, graphical user interfaces, or other methods of depicting information on a computer screen (e.g., commands, links, fonts, colors, layout, sizes and relative positions, and the like). In general, a “link” refers to any resource locator identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single computer environment.

FIG. 4A is an example of a screenshot of a home page 400. The home page 400 of FIG. 4A may represent a portal by which a user enters the aerial mapping facility. For example, it may be utilized to facilitate real estate sales, generate leads for real estate professionals, facilitate entry to agent web sites, and so forth. In addition, the portal can be tailored to provide different aspects to consumers than the aspects provided to real estate professionals. The home page 400 shows a high-level aerial image of an interactive map 402 covering the United States and parts of North America. The user may be provided with various options for interacting with the map 402, including zooming in on aspects of the map using zoom features 404, which may include a click-sensitive map that the user can click on to drill down. For example, a user may be able to click anywhere on the U.S. map to zoom down to an individual home, as shown in a screenshot 420 of FIG. 4B. It may also be possible to reset the map using the zoom features 404 or other features (e.g., shortcut keys).

Additional user interface features may include a SEE AN AERIAL VIEW OF MY HOME feature 406, a SEARCH HOMES FOR SALE feature 408, and a SEE RECENT HOME SALES ON MY STREET feature 410. To provide this information, the map 402 may include an overlay of multiple listing service (MLS) data to display indications of houses that are for sale in an area displayed on the map. Because of the high-level nature of the map 402, as can be expected, the overlay of MLS data is not shown in FIG. 4A, but is shown in subsequent Figures (e.g., FIG. 4D). In this way, the enhanced aerial imagery may generate leads for sales, such as home sales.

A layering tool bar 412 depicted here at the bottom of the map 402 allows a user to select various informational layers that can be applied to the map. Other options for allowing users to select layers may include expandable menus or other UI features. For example, applying a STREETS layer using the layering tool bar 412 will allow users to view street location, names, and numbers when the map is zoomed in to an appropriate level of detail. Similarly, applying a SCHOOLS & PARKS layer using the layer tool bar 412 will display identifiers associated with schools and parks when the map is zoomed in to the appropriate level of detail. An AGENTS layer, if selected, will allow the user to see an indication of any real estate professionals assigned to a particular region. For example, real estate professionals may sign up with and pay a fee to the provider of the aerial mapping facility to be associated with a specific area of the map. A POINTS OF INTEREST layer may also be provided (to display points of interest, e.g., restaurants, shopping centers, airports, etc.) within a given area. Accordingly, the enhanced aerial imagery scheme can be used to generate revenue by promoting particular points of interest (e.g., a two-cent royalty may be collected each time an icon identifying a McDonald's restaurant is displayed on the map). A FACTS layer may allow a user to view more detailed facts (when available) about a particular point or vector on the map. It is not difficult to see that the information associated with the layers described above may be useful to future home buyers, sellers, and real estate professionals, as well as other users.

Referring to FIG. 4C, a screenshot 430 shows a result of the user selecting or clicking on the SEE AN AERIAL VIEW OF MY HOME feature 406. As shown, an ADDRESS text box 432 and a ZIP CODE text box 434 are displayed, into which the user enters his or her address “8301 Overlake Drive” and zip code “98039,” respectively. The user may then submit the information by selecting a GO button 436. As a result of selecting the GO button 436, the user is taken to a page that shows the user's home identified in an enhanced aerial map. An example of such a page is shown in FIG. 4D.

FIG. 4D shows a screenshot 440 of a map 442 after the user has selected to zoom in on his or her own home at “8301 Overlake Drive.” An indication of the user's home 444 is highlighted using a yellow outline (e.g., vector layer). The user may be instructed to click on the identified area to zoom in. In addition to the user's own home, various properties are highlighted using a different color outline, and may indicate homes for sale 446 in the area surrounding the user's own home. This information may be provided based, for example, on an overlay of MLS data, or on other information. The user is also instructed to “Click any property to see more.” In addition, various parks 448 are identified on the map, as the SCHOOLS & PARKS layer is selected in the layering tool bar.

FIG. 4E shows an example of a screenshot 450 of a registration view 452 from which a user may provide registration information. This information may later be used to generate leads for real estate professionals, or for sending notifications to the user. In some embodiments, the registration view 452 may be displayed after the user performs some activity associated with an enhanced aerial map, such as selecting to invoke a SEARCH HOMES FOR SALE feature 408, as shown in FIG. 4A, or clicking on a property on a map that is highlighted as being for sale (e.g., home 446 in FIG. 4D). In some embodiments, the registration is optional, or alternatively required if the user would like to receive further information. The registration view 452 may include an explanation 454 of reasons why a user should register. It may also include a login area 456 for users that have previously registered as well as input fields 458 allowing new users to register. One or more checkboxes may be provided that allow users to elect certain services or features associated with the aerial mapping facility. For example, users may be able to select SHOW ME CURRENT MLS LISTINGS 460, SHOW ME RECENT SALES IN MY AREA 462, and/or SEND ME PINPOINT UPDATES 464. When a user completes registration or login, the user may then select a GO button 466 to submit the information.

FIG. 4F is a screenshot 470 showing an agent-specific screen 472 that may be displayed to the user after he or she selects the GO button from the registration view 452 of FIG. 4E. The agent-specific screen 472 may include an agent banner 474 that identifies the real estate professional(s). The agent-specific screen 472 may also display a property summary 476 that provides detailed information for the initial property that the user selected to be brought to the agent-specific screen 472. In some embodiments the user may select from various tabs 478 and/or subtabs 480 provided on the agent-specific screen 472. Examples of such tabs 478 include a HOME tab, a SEARCH FOR PROPERTIES tab, a VIEW RECENT HOME SALES tab, a RESOURCES tab, an ABOUT US tab, etc. Many of these tabs are self-explanatory. In the illustrated example, a SEARCH FOR PROPERTIES tab is selected, and results in the display of various subtabs 480 including a BASIC SEARCH subtab, an ADVANCED SEARCH subtab, a PROPERTY RESULTS subtab (currently selected), a PROPERTY DETAILS subtab, a MY FAVORITES subtab, a MY SAVED SEARCHES subtab, etc. As with the tabs 478, the subtabs 480 shown in the illustrated example are self-explanatory. The property results subtab is shown in more detail, and provides various listings 482 within a given area, as well as an interactive map 484 and related features.

FIG. 4G is a screenshot 490 showing a property details screen or view 492 associated with a property details subtab on the agent-specific screen 472 (also displayed in FIG. 4F). In the illustrated example the property details view 492 shows a property summary 494 and provides access to various images of the selected property via thumbnails 496 and a general image 498. Other examples of information that can be shown in the property details view 492 include a virtual tour (e.g., panning images showing different views of a room in a house), video, etc.

While not shown in the Figures, other interactive map options may be provided. For example, some enhanced aerial maps may provide access to “coupons” associated with businesses. Such coupons may be presented (e.g., via a web site or pop-up) when a user clicks an indication of specially marked businesses (e.g., highlighted in yellow or some other color on the aerial map). Revenue can be generated accordingly (e.g., for just posting the coupon, for each impression, for each click-through, for a percentage of each sale, etc.).

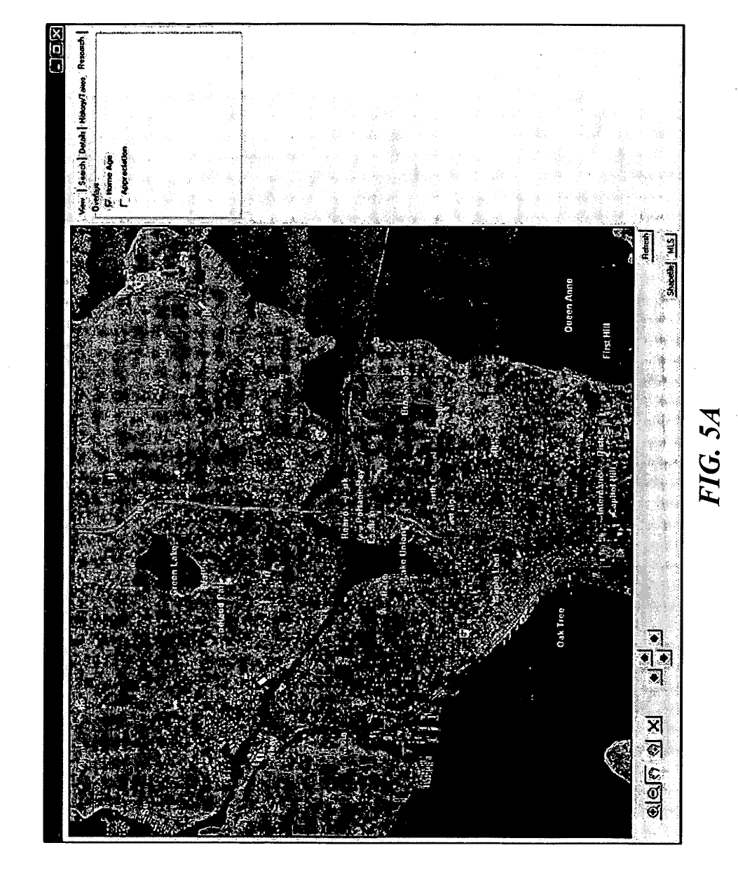

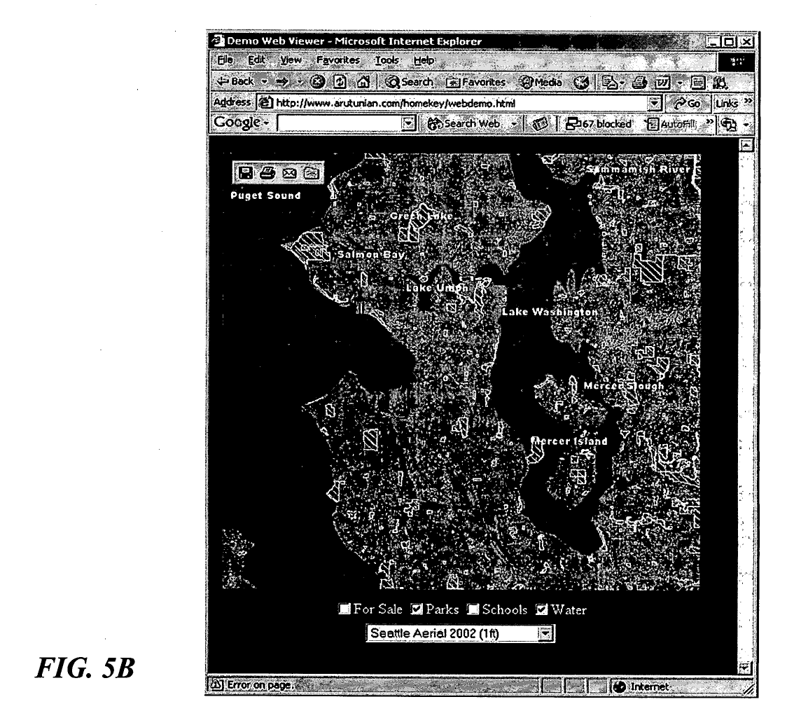

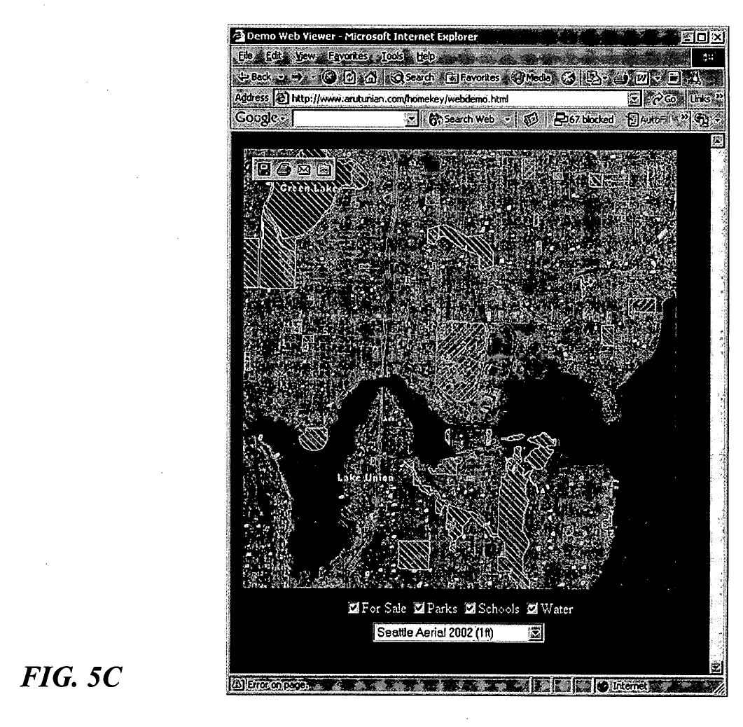

FIGS. 5A-5C and 6-8 are display diagrams showing examples of data overlay schemes (e.g., layers) that may be applied by the aerial mapping facility. This data can include any type of location-based data, such as real estate data, points of interest (commercial establishments), and so forth. For example, FIG. 5A shows a home age overlay “heat map” where the aerial map is displayed showing various colors assigned based on the age of homes. For example, dark red may indicate older homes (early 1900s), orange may indicate homes from the 1950s and 1960s, and yellow may indicate newer construction. Other interesting categories could also be mapped (e.g., appreciation, taxes, sales price, etc.). In this way it is easy for users to locate concentrations of homes based on age, appreciation, etc. Likewise, FIG. 5B shows an overlay of parks and water, while FIG. 5C shows an overlay of homes for sale, parks, schools, and water, all in combination. By providing features such as these, the aerial mapping facility may allow future homeowners to become more familiar with important factors within the areas in which they are looking to buy. In turn, this will attract more users (and return users) to the web site, and thereby generate more leads, advertising opportunities, etc.

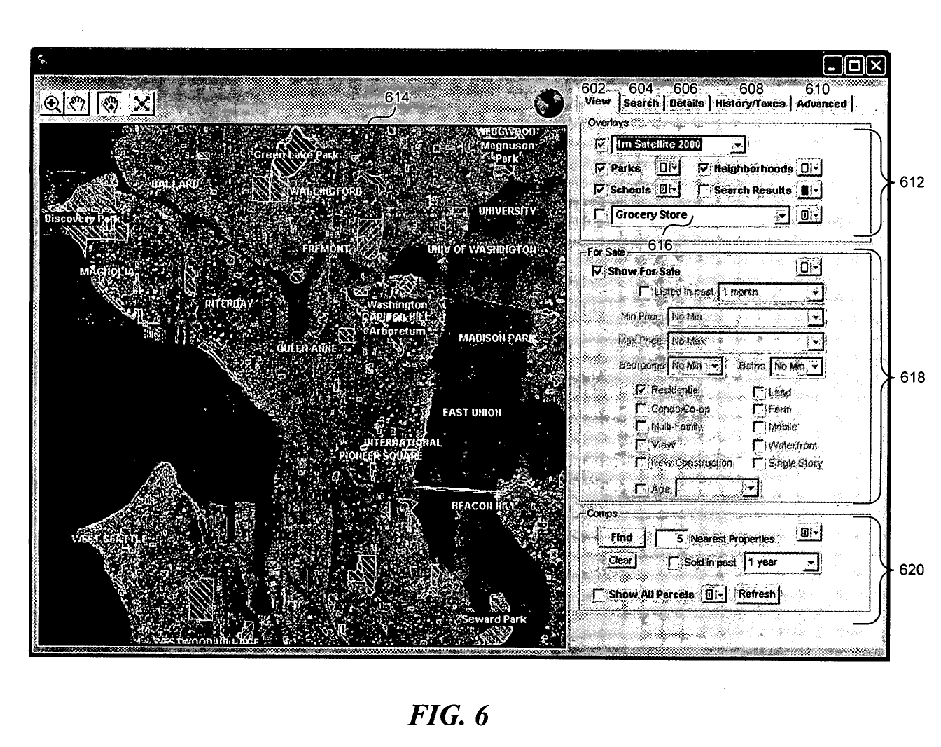

FIGS. 6-8 show various examples of one embodiment of the aerial mapping facility where users can access various overlays and associated features through the use of tabs on a user interface. Referring to FIG. 6, examples of such tabs include a VIEW tab 602, a SEARCH tab 604, a DETAILS tab 606, a HISTORY/TAXES tab 608, and an ADVANCED tab 610. As shown in FIG. 6, the VIEW tab 602 may include an OVERLAYS section 612, which allows users to select various overlays (e.g., parks, schools, neighborhoods, etc.) to apply to an interactive aerial map 614. Each selected overlay may then be associated with a particular color on the map. The OVERLAYS section 612 may also provide access to a customizable overlay via a search field 616, where the user may enter in keywords to identify points of interest (e.g., grocery stores) so that locations associated with such search results may be displayed on the interactive aerial map 614. A FOR SALE section 618 may provide input fields so that a user can filter out homes for sale in the area that meet specified requirements (e.g., price range, residential versus condominium, number of bedrooms, etc.). Likewise, a COMPS 620 section may allow a user to input information so that the user can see what other comparable homes have sold for in the recent past.

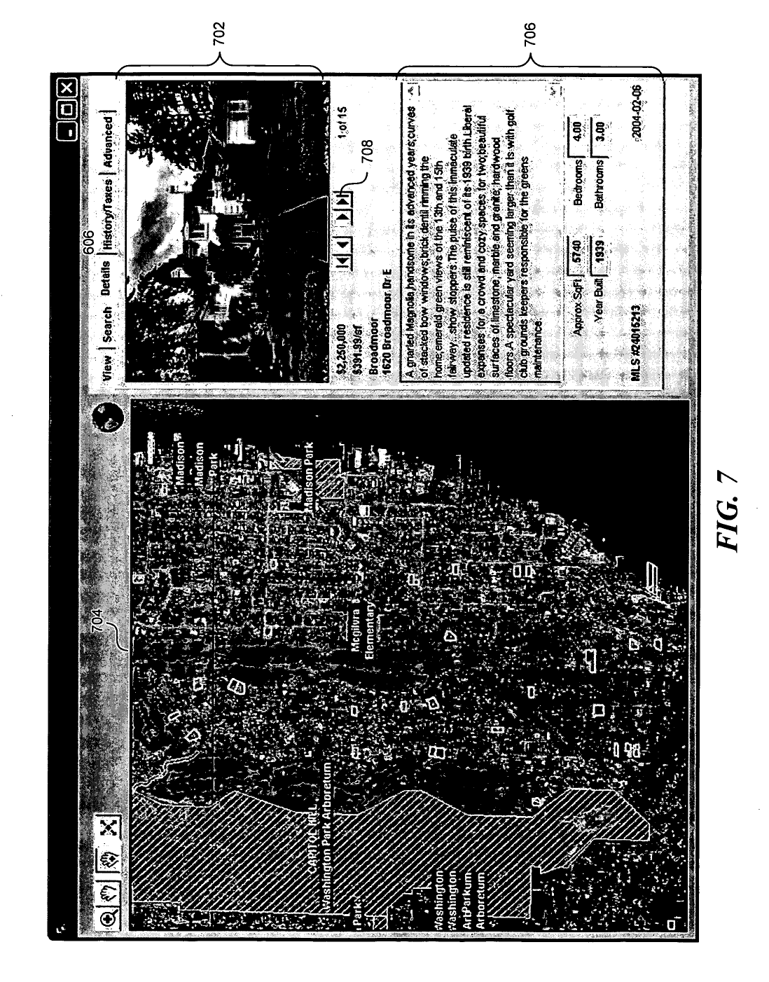

FIG. 7 shows an example of information provided under the DETAILS tab 606. For example, the DETAILS tab 606 may provide a photograph 702 of a selected home (identified using a unique color outline on a map 704), as well as a detailed description 706 of the home. Using a forward/backward feature 708, it may be possible to scroll to detailed information about another home displayed on the map.

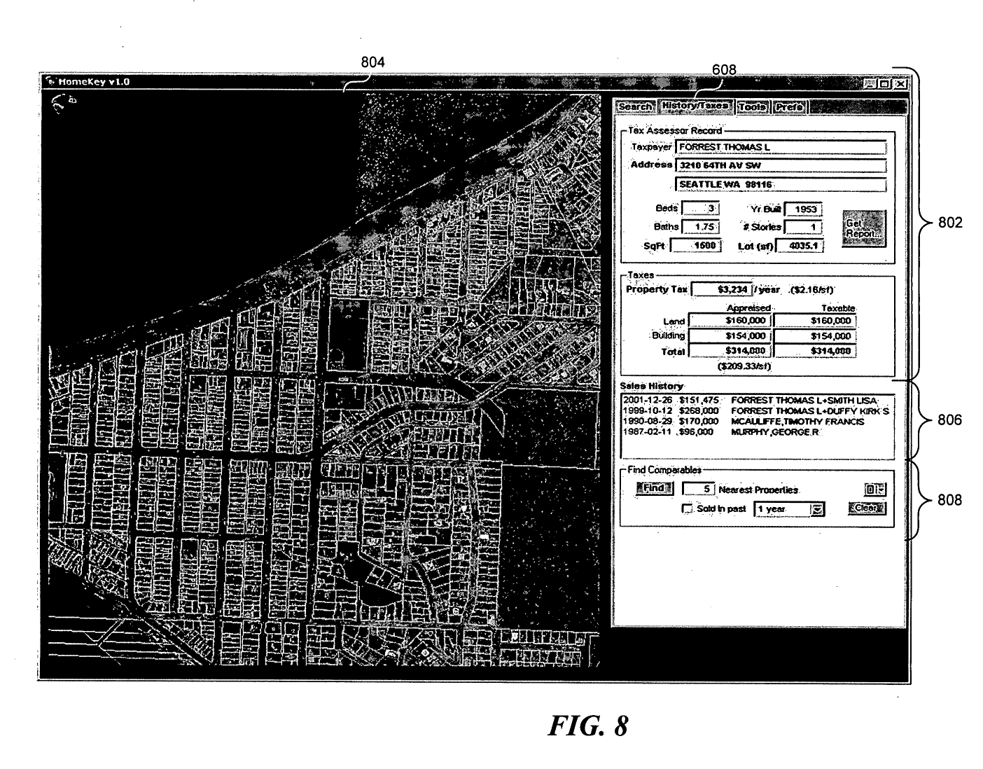

FIG. 8 shows an example of information provided under the HISTORY/TAXES tab 608. For example, FIG. 8 shows basic tax information 802 for a selected residence, as well as a map 804 with tax plats shown in red outlines. In addition to basic tax information, the aerial mapping facility may provide tax information for recent sales of the selected home 806, as well as a feature 808 that allows users to find comparable properties in the area (e.g., comparable with respect to tax information).

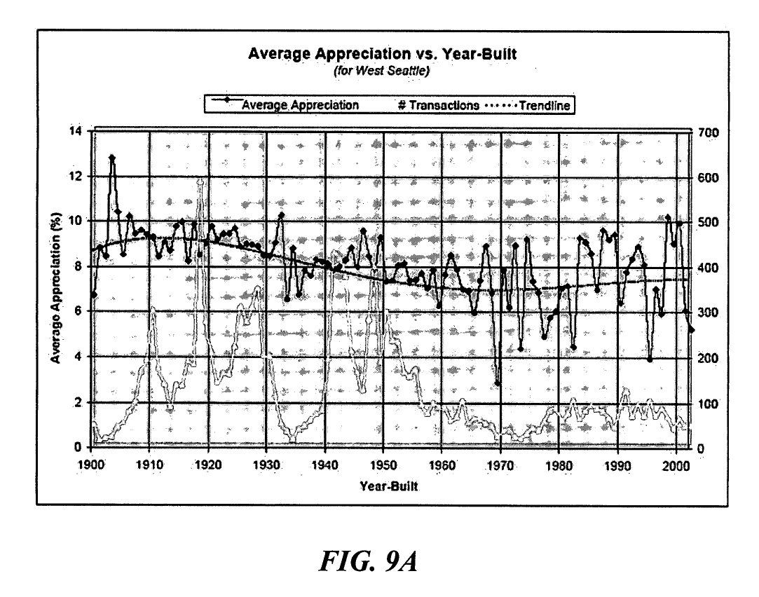

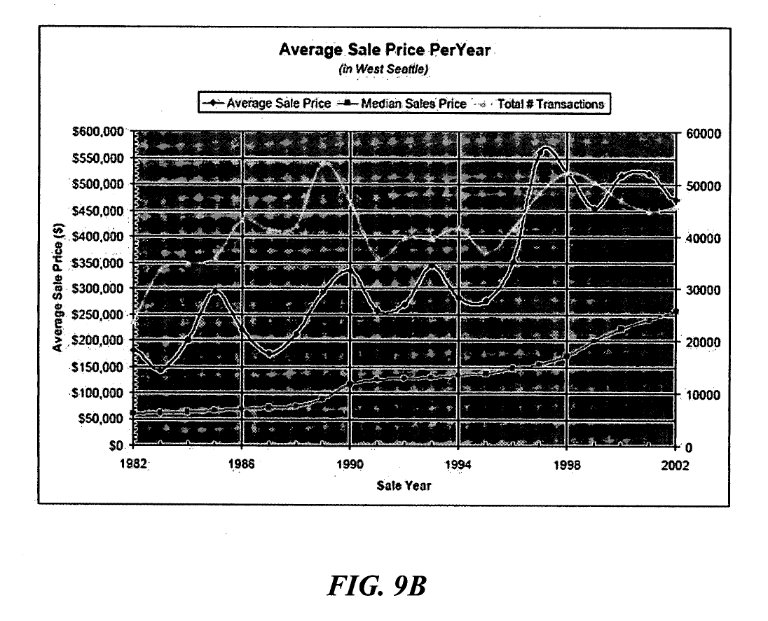

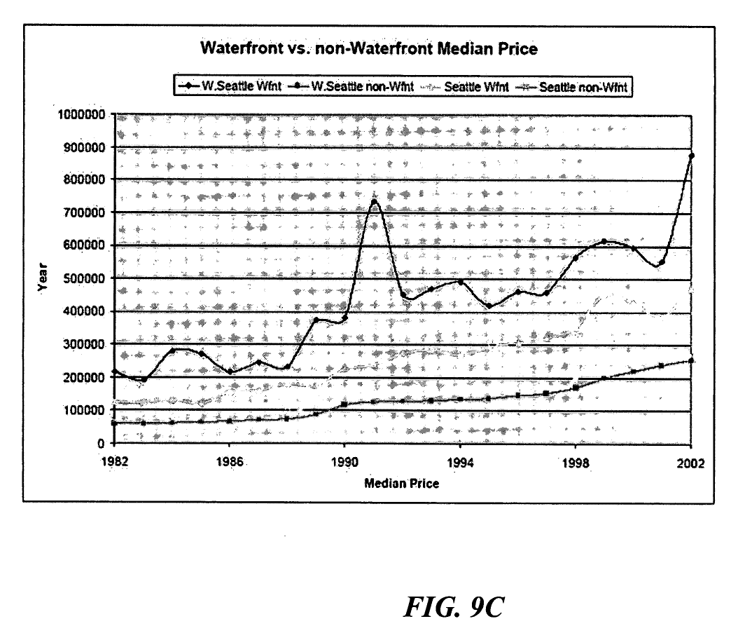

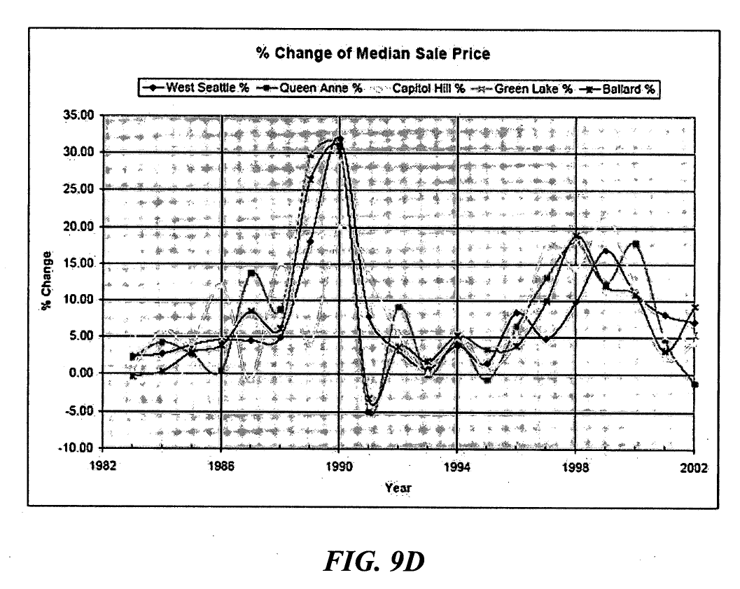

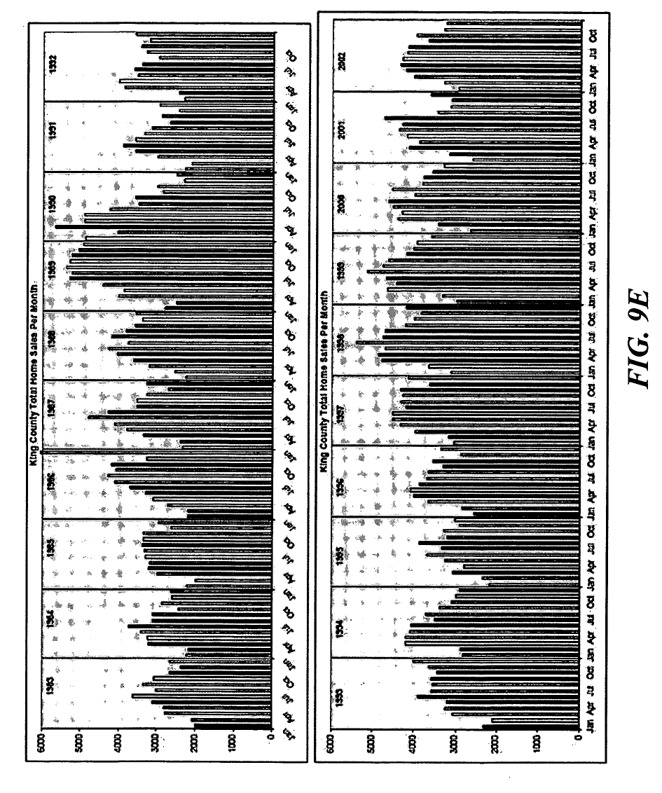

FIGS. 9A-9E provide examples of data charts/reports used in conjunction with the enhanced aerial maps. For example, these reports may provide statistical information as well as data comparisons among selected neighborhoods, areas, groups of homes, etc. FIG. 9A is an example of a report that provides information on average appreciation of homes in a given set of areas versus the year built. FIG. 9B is an example of a report that identifies the percentage by which the median sales price has changed for Seattle neighborhoods over a 20-year period. FIG. 9C is an example of a report that shows how waterfront home values in a given area fluctuate more greatly than non-waterfront homes in the same area. FIG. 9D is an example of a report that shows a change of median sale price for selected neighborhoods over time. FIG. 9E is an example of a report that shows trends in King County home sales volume over 20 years.

IV. Lead Generation Examples

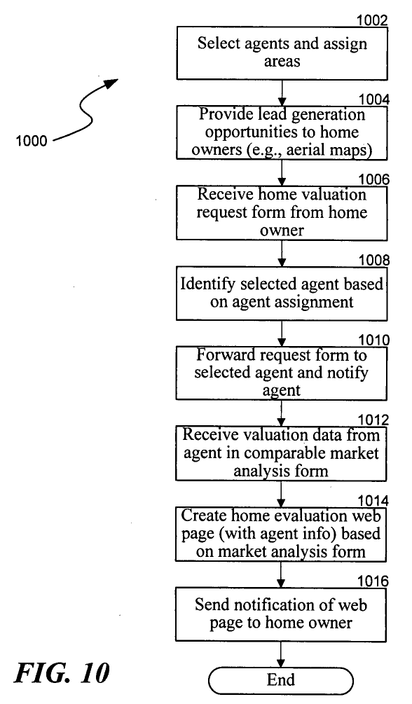

FIG. 10 is a flow diagram of a representative implementation of a lead generation routine 1000, possibly used in combination with the enhanced aerial imaging techniques described above. Beginning at block 1002, the routine 1000 (e.g., via the lead generation server 118 of FIG. 1) identifies real estate professionals and assigns them to particular zip codes or other designations in the appropriate database (e.g., the user database 120 of FIGS. 1 and 3). For example, each real estate professional may be assigned a database record, as described in more detail with respect to FIG. 3. At block 1004, the routine 1000 presents lead generation opportunities to homeowners, potential home buyers, or other members of the public. An example of such lead generation opportunities includes the aerial maps described above. Additional lead generation opportunities may result from posting banner advertisements on selected web pages or sending targeted email messages or other direct advertisements to the client computers 102. The costs for the advertisements may be billed based on the number of homeowner visits to the web site, or the number of homeowners who visit the web site and actually complete a web page form, or by other methods, including methods described above relating to aerial maps.

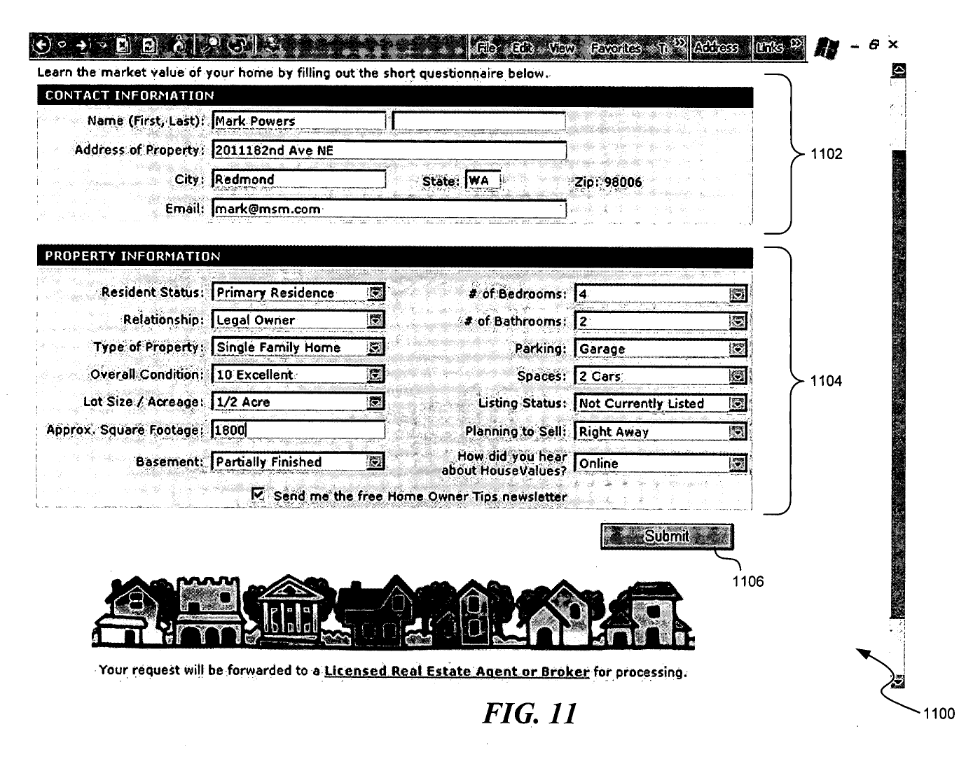

At block 1006, the routine 1000 receives a home valuation request form or home inquiry request form from a homeowner. For example, in the illustrated embodiment of FIG. 1, the client computer 102, via the browser 104, may retrieve a display description, e.g., a web page information request form from the web page manager component 122 of the intermediary facility 108. An example of such a request form is shown with respect to FIG. 11 (and also with respect to FIG. 4E), and may be displayed after a user selects a home using an enhanced aerial imagery map. A request form 1100 includes fields to be filled in by the homeowner (or future home buyer), some of which include drop-down entries or buttons to permit the user to select one of several options. As shown, the request form 1100 may include contact information 1102 for the homeowner (or future home buyer) (e.g., property's address; property's zip code; neighborhood name; homeowner's/buyer's name; homeowner's/buyer's address, including city, state, and zip code; home phone; work phone; email address, etc.) and property information 1104 (e.g., type of property; style of home; approximate year built; number of bedrooms; number of full bathrooms; number of half bathrooms; number of fireplaces; square footage; parking spaces; list of recent improvements; primary/rental home; rating of overall condition; when the homeowner plans to sell; where the homeowner is moving; whether the home is currently listed with an agent; how the homeowner heard about the existence of the web site listing this form; whether the homeowner would like to receive a newsletter, etc.). After the homeowner/future home buyer has filled out the fields in the request form 1100, the homeowner selects a submit query button 1106 to send the completed form from the client computer 102 to the intermediary facility 108, via the Web 106.

While not shown, the request form 1100 may also include other features such as a mortgage calculator, a moving calculator, an insurance professor, a library, a relocation wizard, etc. For example, the mortgage calculator determines home buying power from the point of view of a lender by analyzing a broad spectrum of financial and mortgage scenarios. The moving calculator estimates high and low estimates of moving costs for local and long-distance relocations. The insurance professor compares insurance rates in a number of cities for a variety of insurance carriers. The library includes various articles or other data relevant to a homeowner who is interested in selling a home. The relocation wizard provides a personalized and detailed relocation time line that helps homeowners get and stay organized before and during a move. Other features (not shown) may include a home seller tips section, which provides tips on helping a homeowner sell a home. These and other features are known to those skilled in the relevant art and need not be described in further detail herein.

At block 1006, the routine 1000 adds the data in the received request form 1100 to the appropriate database (e.g., the user database 120 of FIGS. 1 and 3). At block 1008, the routine 1000 identifies a selected agent in the appropriate database. For example, with respect to the components of FIG. 1, the database manager component 124, together with the lead generation server 118, queries the user database 120 for the record having an assigned zip code field with a zip code that matches a zip code field in the received request form 1100. Other mappings (besides zip code mappings) may be possible.

At block 1008, the routine 1000 provides a reply to the homeowner/future home buyer who submitted the request form 1100. For example, with respect to the components of FIG. 1, the notification process 128 may send a thank you email message to a homeowner based on the email field in the request form 1100. The email message may acknowledge receipt of the request form 1100 and thank the homeowner for submitting such a request, as well as provide additional information such as when he or she may expect to receive a response.

At block 1010, the routine 1000 forwards the request form 1100 to the identified agent and notifies the identified agent. For example, with respect to the components of FIG. 1, the notification process 128 of the intermediary facility 108 may automatically create an email message or other notification for the agent computer 112 of the identified agent, and send such message over the Web 106. In some embodiments, the notification process 128 provides not only email notification to the identified real estate professional, but also notification messages via wireless communication devices. For example, under such an embodiment, the notification process 128 provides a notification message to a telecommunications interface. The telecommunications interface, in turn, provides a notification message to a cellular phone (e.g., in the form of a prerecorded audio message), or to a pager (e.g., in the form of an alphanumeric text message). The prerecorded audio message and/or alphanumeric text message inform the identified real estate professional that he or she has a pending request from a homeowner for a comparable market analysis (“CMA”).

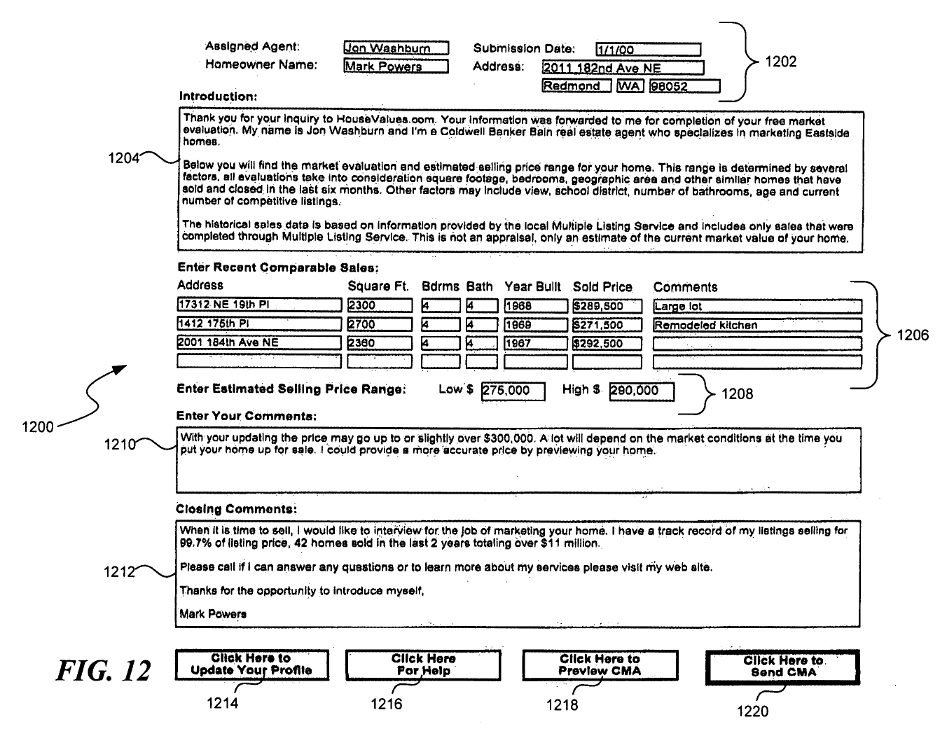

At block 1012 (which applies primarily to the case where a home seller has submitted a request), the routine 1000 receives valuation data from the real estate professional who has completed a comparable market analysis to estimate a selling price for the home identified in the form. For example, this comparable market analysis may be based on local knowledge, data from the homeowner's completed request form 1100, and data collected from multiple listing services. FIG. 12 shows an example of a comparable market analysis form 1200. The various fields of the comparable market analysis form 1200 are generally self-explanatory. For example, header fields 1202 include the assigned real estate professional's name, homeowner's name, submission date and address, which in FIG. 12 are “Jon Washburn,” “Mark Powers,” “Jan. 1, 2000,” and “2011 182nd Avenue N.E., Redmond, Wash. 98052,” respectively. An introduction field 1204 may allow the real estate professional to personalize an introductory message to be included in a home evaluation web page that the system makes available to the homeowner (as described below). Recent comparable sales fields 1206 provide four rows of input fields for the real estate professional to list up to four comparable recently sold homes. Data to be completed in the fields include address, square footage, bedrooms, bathrooms, year built, sold price, and comments. Estimated selling price fields 1208 provide low and high estimated selling price fields for the real estate professional to fill in based on the recent comparable sales fields 1206. A comments field 1210 may allow the real estate professional to add some additional comments regarding the estimated selling price. A closing comments field 1212 may allow the real estate professional to provide some additional information regarding the selling prices and home sales and provide personalized closing text for the home evaluation web page noted below. The comparable market analysis form 1200 also includes four buttons. An update button 1214 may allow the real estate professional, after clicking the button, to update the homeowner's profile (described below). A help button 1216 may allow the real estate professional to access help instructions stored in the appropriate database or otherwise contact technical support. A preview CMA button 1218 may allow the real estate professional to view a preview of the home evaluation web page, while a send CMA button 1220 sends the completed market analysis form 1200. After completing the form 1200, the identified real estate professional clicks the send CMA button 1220, at which time the real estate professional computer, such as the agent computer 112 of FIG. 1, transmits the completed market analysis form 1200 to the intermediary facility 108 to be stored in the database 120.

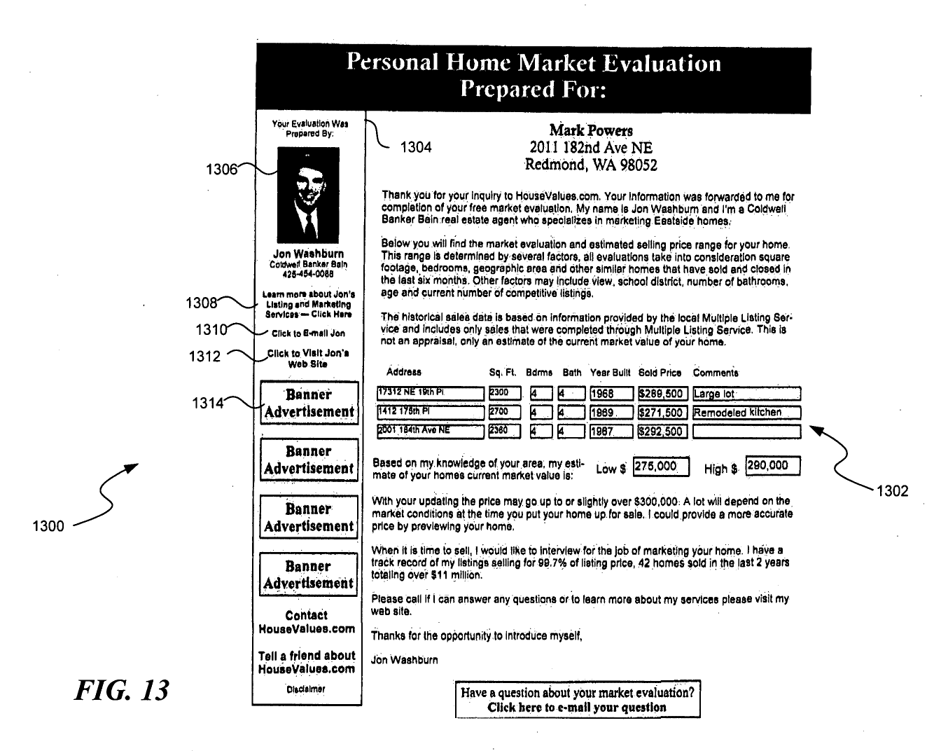

At block 1014, the routine 1000 stores the received market analysis form 1200 in the appropriate database and creates a home evaluation web page for the homeowner based on the received (and stored) market analysis form 1200. An example of a home evaluation web page 1300 is shown in FIG. 13. Again, the home evaluation web page 1300 is generally self-explanatory. A central section 1302 may include most of the information that the real estate professional input to the comparable market analysis form 1200 (e.g., homeowner's name and address from the header fields 1202, text from the introduction field 1204, the recent comparable sales fields 1206, estimated selling price fields 1208, comments field 1210, and closing comments field 1212). The central section 1302 may also include all of the comparable market analysis data requested by the homeowner, and may provide this data in a personalized manner to the homeowner as if from the real estate professional directly. The home evaluation web page 1300 may also include a frame section 1304 that provides a profile and introduction of the identified real estate professional. The frame section 1304 includes a bitmapped image portion 1306 displaying an image of the real estate professional, together with several links to the real estate professional's web site. A biography or information link 1308 may allow a homeowner to link from the home evaluation web page 1300 to a web page describing the real estate professional's marketing services, current house listings, and other information about the real estate professional. An email link 1310 may allow a homeowner to quickly and efficiently send the real estate professional an email. A web site link 1312 may allow a homeowner to access the real estate professional's customized web site. The frame section 1304 also includes one or more banner advertisements 1314 that display advertisements to further generate revenue for the intermediary facility operator.

At block 1016, the routine 1000 provides an email message or other notification to the homeowner identifying, and providing a link to, the created home evaluation web page. For example, with reference to the components of FIG. 1, the notification process 128 may send a notification email message to the homeowner in a manner similar to the email notification described at block 1008. The email notification includes a URL link to the created home evaluation web page.

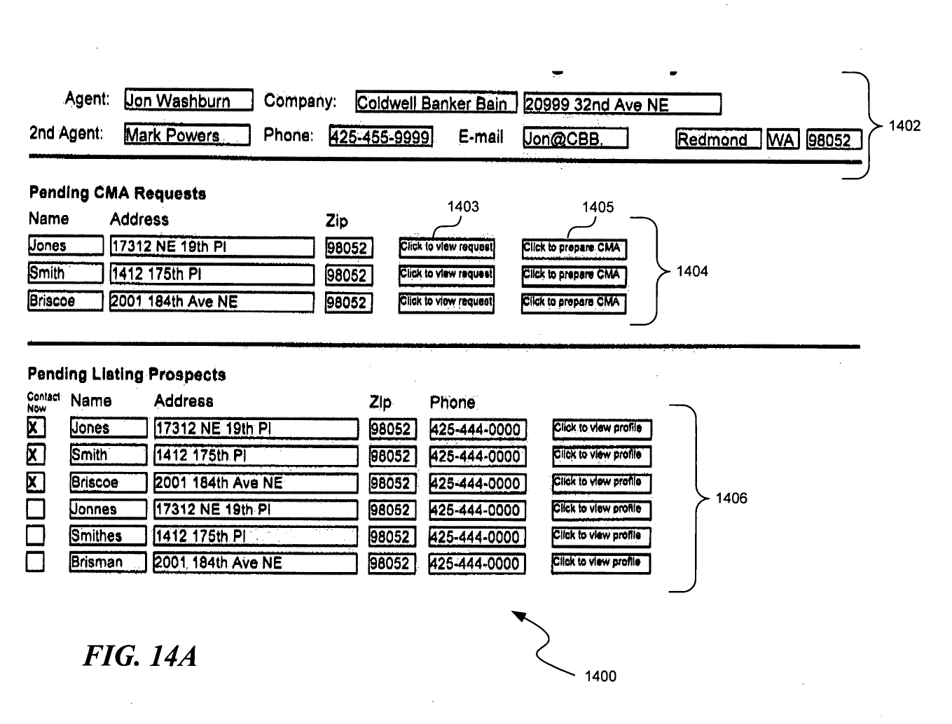

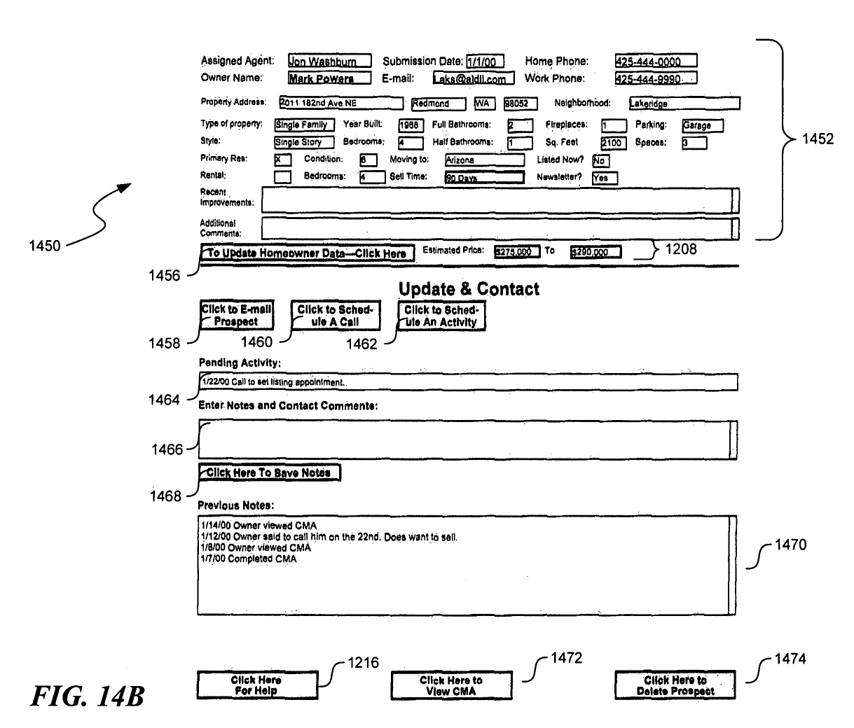

After the routine 1000 ends, other activities may take place. For example, with respect to the component of FIG. 1, the intermediary facility 108 and database manager component 124 of FIG. 1 may update the identified real estate professional's contact management data in the database 120. An example of a contact management web page 1400 is shown in FIG. 14A. Again, the contact management web page 1400 is generally self-explanatory. Header fields 1402 include the real estate professional's name, company, address, phone number, email address, and designation of a second real estate professional, if applicable. A pending CMA request section 1404 includes one or more rows of pending CMA requests, with each row including a last name, address, zip code, and two buttons or links 1403 and 1405 to permit the real estate professional to review a pending CMA request and to prepare a CMA, respectively. A pending listing prospects section 1406 includes lists of leads or prospects for which a CMA (home evaluation web page) has been completed. Each row contains many of the same fields as that for the pending CMA request section 1404, except that a link is not provided to prepare a CMA (because one has already been prepared) but does include a “Contact Now” field to notify the real estate professional that a pending lead should be contacted.

Referring to FIG. 14B, the profile web page 1450 may include detailed information with respect to each lead in the real estate professional's contact management system. As shown in FIG. 14B, a header section 1452 may include much of the data from fields in a completed web page form. An update homeowner data button 1456 may allow the real estate professional, when clicking thereon, to update the information in the header section 1452. An email prospect button 1458 may allow the real estate professional to quickly and efficiently send an email to the lead whose profile web page 1450 is currently open. A call button 1460 and schedule an activity button 1462 allow the real estate professional to automatically schedule a reminder for a telephone call or follow-up activity, respectively, with the lead whose profile web page 1450 is currently open. A pending activity field 1464 lists a call or activity scheduled by the button 1460 or 1462. A comments field 1466 may allow the real estate professional to input comments based on a call or activity with a lead, while a save button 1468 may allow the real estate professional to save such comments. A previous notes field 1470 displays comments previously saved by the real estate professional. A view CMA button 1472 causes the web page manager component 122 to display a home evaluation web page for the current lead, while a delete button 1474 may allow the real estate professional to delete the profile web page 1450 for the current lead.

In the illustrated embodiment, the contact management web page 1400 and profile web page 1450 may permit the identified real estate professional to identify all pending leads or contacts (homeowners who have submitted a completed request form); data on past contacts/homeowners; agent notes covering conversations or other transactions with contacts, sellers, or homeowners; calendar scheduling information to plan future contacts; and assign an outcome to each lead such as listed and sold, listed with another real estate professional, sold for sale by owner, not planning to sell, etc., and then allow the deletion of a lead.

V. Conclusion

One skilled in the relevant art will appreciate that the concepts of the invention can be used in various environments other than described in detail herein. In general, a display description may be in HTML, XML or WAP format, Flash, email format, or any other format suitable for displaying information (including character/code-based formats, algorithm-based formats (e.g., vector generated), and bitmapped formats). Also, various communication channels, such as local area networks, wide area networks, or point-to-point dial-up connections, may be used instead of the Internet. The system may be conducted within a single computer environment, rather than a client/server environment. Also, the user computers may comprise any combination of hardware or software that interacts with the server computer, such as television-based systems, Internet appliances, and various other consumer products through which data retrieval and display may be conducted, such as wireless computers (palm-based, wearable, mobile phones, etc.). The various aspects of the invention described herein can be implemented in or for any email environment.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled,” as generally used herein, refers to two or more elements that may be either directly connected or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

Aspects of the invention may be stored or distributed on computer-readable media, including magnetically or optically readable computer disks, hard-wired or preprogrammed chips (e.g., EEPROM semiconductor chips), nanotechnology memory, biological memory, or other data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described above can be combined to provide further embodiments. Any patents, applications, or other references noted herein, including any that may be listed in accompanying filing papers, are incorporated herein by reference. This includes U.S. patent application Ser. No. ______, filed Aug. 19, 2005, entitled “Enhanced Imagery, such as for Lead Generation for Service Providers Who Provide Services Associated with Real Estate” (attorney docket no. 322808002US2); U.S. patent application Ser. No. ______, filed Aug. 19, 2005, entitled “System and Method Utilizing Enhanced Imagery and Associated Overlays” (attorney docket no. 322808003US); U.S. patent application Ser. No. ______, filed Aug. 19, 2005, entitled “Server-Based Interactive Enhanced Map Imagery Engine” (attorney docket no. 322808004US); U.S. patent application Ser. No. ______, filed Aug. 19, 2005, entitled “Notifications Using Enhanced Map-Based Imagery” (attorney docket no. 322808005US); and U.S. patent application Ser. No. ______, filed Aug. 19, 2005, entitled “Enhanced Map Imagery, such as for Location-Based Advertising and Location-Based Reporting” (attorney docket no. 322808006US), all herein incorporated by reference.

Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

One skilled in the art will appreciate that the concepts of the present invention can be used in various environments other than the Internet. For example, the concepts can be used in an electronic mail environment in which electronic mail forms and messages perform the lead generation processes. Also, while the one intermediary facility 108 is shown, any server system may be used, including any combination of hardware or software that can support the concepts and aspects of the invention disclosed herein. In particular, a web server may be used that includes multiple computers. A client computer or system may comprise any combination of hardware or software that interacts with the server computer or system. These client systems may include television-based systems and various other consumer products through which commercial or noncommercial transactions can be conducted.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other electronic commerce systems, not necessarily the real estate lead generation system described above. Indeed, the invention applies to agents or service providers in other fields, not necessarily real estate professionals, and to property owners, not necessarily homeowners. Further, the various embodiments described above can be combined to provide further embodiments.

These and other changes can be made to the invention in light of the above detailed description. In general, in the following claims, the terms used should not be construed to limit the invention to the specific embodiments disclosed in the specification and the claims, but should be construed to include all machine vision systems that operate under the claims to provide a method for accurately locating visual indicia. Accordingly, the invention is not limited by the disclosure, but instead the scope of the invention is to be determined entirely by the following claims.

I/We claim:

1. A computer-implemented lead-generation method comprising:
providing access to a map via a communication network wherein the map comprises:
multiple map images set at multiple resolutions, wherein the multiple map images are configurable to display a representation of a geographical area and to display one or more close-up views of portions of the geographical area; and
at least one data overlay showing information of interest, wherein the information of interest is associated with at least one location in the geographical area, and wherein the at least one data overlay is displayable on the map;
collecting information associated with access, use, or display of the provided map, wherein the collected information includes contact information for at least one user of the map; and
based on the collected information, generating a lead or set of leads for use by at least one service or product provider, wherein the service or product provider is associated with the geographical area.

2. The method of claim 1, further comprising:
charging a fee to the service or product provider in association with generating the lead or set of leads.

3. The method of claim 1 wherein the at least one data overlay includes an overlay from a group comprising:
restaurant information;
retail store information;
service station information;
professional services information; and
car dealership information.

4. The method of claim 1 wherein the access to the map includes access to a user interface that allows a user to select one or more data overlays to apply to the map.

5. The method of claim 1 wherein each of the multiple map images is configured as a map tile at a given resolution.

6. The method of claim 1 wherein each of the multiple map images is configured as a map tile at a given resolution, wherein the map tile is a two-dimensional image of a three-dimensional surface, and wherein a mathematical function is used in transforming characteristics of the three-dimensional surface for the two-dimensional image.

7. The method of claim 1 wherein each of the multiple map images is configured as a map tile at a given resolution, wherein the map tile is a two-dimensional image of a three-dimensional surface, wherein a mathematical function is used in transforming characteristics of the three-dimensional surface for the two-dimensional image, and wherein a similar mathematical function is applied to the at least one data overlay prior to its display on the map.

8. The method of claim 1 wherein collecting information associated with using the provided map includes providing an opportunity for user registration.

9. The method of claim 1 wherein collecting information associated with using the provided interactive aerial map includes providing an opportunity for a user to view commercial points of interest in a selected area and requesting the user to register prior to displaying the commercial points of interest.

10. A lead generation system comprising:
a map server system configured for generating maps for display at client computers, the map server system including:
a data store for storing multiple map images set at multiple resolutions, wherein the multiple map images are configurable to display a representation of a geographical area and to display one or more close-up views of portions of the geographical area;
a data store for storing overlay information used in generating displayable overlays on the maps, wherein the overlay information includes information about commercial or non-commercial points of interest;
an overlay generator tool configured to generate the displayable overlays on the maps based on least a portion of the overlay information and at least a portion the map images; and
a user data collection component for collecting information associated with access, use, or display of the maps, wherein the collected information includes contact information for at least one user of the maps; and
a lead generation engine configured for generating a lead or set of leads for at least one service or product provider, wherein the service or product provider is associated with the geographical area.

11. The system of claim 10 wherein the overlay information includes indications of service or product locations.

12. The system of claim 10 wherein the overlay information includes graphics or symbols that can be selected to result in the display of more detailed information.

13. The system of claim 10 wherein the overlay information includes current weather or traffic information.

14. The system of claim 10 wherein the overlay information includes indications of comparative costs of services or products.

15. The system of claim 10, further comprising:
a data store for storing information about service or product providers registered to use the system.

16. A computer-implemented map-generation method comprising:
receiving a request for map information from a client computer, wherein the request for map information is related to a geographical area defined, at least in part, using a set of coordinates;
providing a set of map tiles to the client computer in response to the request, wherein each of the map tiles comprises an image of a portion of the geographical area, wherein the image of the portion of the geographical area is generated, at least in part, using a mathematical projection for transforming features of a three-dimensional surface into a two-dimensional image; and
providing a map overlay information in association with the set of map tiles, wherein the provided map overlay information is defined, at least in part, using a second set of coordinates, wherein the map overlay information is for display in association with the map tiles, and wherein the map overlay information is generated, at least in part, using a mathematical projection that facilitates the alignment of the first set of coordinates and the second set of coordinates.

17. The method of claim 16, further comprising:
receiving a second request for map information tiles, wherein the second request for map information is related to a specified subportion of the geographical area; and
providing a second set of map tiles in response to the request, wherein each of the map tiles from the second set of map tiles comprises an image of a portion of the subportion of the geographical area.

18. The method of claim 16, further comprising:
collecting information in association with a use or display of the provided set of map tiles and the provided overlay information; and
generating a lead or set of leads based on the collected information, wherein the lead or set of leads provides a potential customer's contact information to a provider of a service or product related to the geographical area.

19. The method of claim 16 wherein the provided overlay information includes indications of commercial points of interest.

20. The method of claim 16 wherein the provided overlay information is interactive and is configured so that its contents can be filtered via user input commands.

21. The method of claim 16, further comprising:
receiving a second request for map information, wherein the second request for map information is related to a specified subportion of the geographical area; and
providing a second set of map tiles in response to the request, wherein each of the map tiles from the second set of map tiles comprises an image of a portion of the subportion of the geographical area, and wherein the first set of map tiles is cached at the client computer for later use.

22. The method of claim 16, further comprising:
providing a second set of map tiles, wherein each of the map tiles from the second set of map tiles comprises an image of a portion of a geographical area adjacent to the subportion of the geographical area, wherein the second set of map tiles is used for providing panning capabilities.
